(19) United States
(12) Patent Application Publication
(10) Pub. No.: US 2008/0138675 A1
(43) Pub. Date: Jun. 12, 2008

(54) Hydrogen generation and storage method for personal transportation applications

(76) Inventors: Bor Z. Jang, Centerville, OH (US); Aruna Zhamu, Centerville, OH (US)

Correspondence Address: Bor Z. Jang, 9436 Parkside Drive, Centerville, OH, 45458, US

(21) Appl. No.: 11/636,706

(22) Filed: Dec. 11, 2006

(51) Int. Cl. H01M 8/04

(52) U.S. Cl. 429/17

(57) ABSTRACT

A hydrogen generation and storage method for producing and storing hydrogen at a home or business site that enables refueling hydrogen to a personal vehicle at a convenient location. The method comprises (a) operating a solar energy conversion subsystem to capture and convert solar radiation into both electrical energy and thermal energy; (b) operating a fuel cell electrolyzer that uses the converted electrical energy and thermal energy to split water into hydrogen and oxygen wherein the fuel cell electrolyzer operates at a temperature between 80° C. and 300° C.; and (c) operating a hydrogen storage means to store the generated hydrogen. The hydrogen storage means preferably comprises (1) a hydrogen storage container comprising a metal hydride, chemical hydride, or other solid or liquid phase material as a storage medium to capture and store the generated hydrogen; and (2) control means to regulate the uptake of hydrogen in the storage container.

### FIELD OF THE INVENTION

This invention provides a personal hydrogen-fueling method, particularly for implementation at a home or business site. This invention provides an efficient method of utilizing solar energy, in the form of both converted electrical energy and thermal energy, to electrolyze water or aqueous electrolyte into hydrogen and oxygen and safely storing hydrogen in a relatively high-capacity medium at a relatively low pressure.

### BACKGROUND OF THE INVENTION

The push toward a hydrogen economy has been a national initiative in the United States in order to achieve independence from foreign oil and to reduce carbon dioxide emissions. Globally, hydrogen-based alternative energy initiatives are rapidly emerging as global warming and other related environmental issues are being increasingly recognized.

At the heart of the hydrogen economy is the development of high-efficiency fuel cells to generate power and the convenient and cost-competitive supply of hydrogen to end users. A fuel cell converts chemical energy into electrical energy and some thermal energy by means of a chemical reaction between hydrogen-containing fuel and oxygen. As compared to other power sources, fuel cells provide advantages that include low pollution, high efficiency, high energy density and simple fuel recharge. Fuel cells can be used in electrochemical engines for all kinds of vehicles, portable power supplies for various microelectronic and communication devices, standby power supply facilities, power generating systems, etc. Further, fuel cells utilize renewable resources and provide an alternative to burning fossil fuels to generate power.

For fuel cell applications, hydrogen is the “ultimate fuel.” Hydrogen is practically inexhaustible since it is the most plentiful element in the universe (over 95% of all matter). Furthermore, hydrogen is an inherently low cost fuel. Hydrogen has the highest energy density per unit weight of any chemical fuel and is essentially non-polluting since the main by-product of “burning” hydrogen is water. Thus, hydrogen can be a means of solving many of the world's energy related problems, such as global warming, pollution, strategic dependency on oil, etc. Hydrogen can be produced by various processes which split water into hydrogen and oxygen or which oxidize methanol or ethanol into hydrogen and other molecules. The hydrogen can then be stored and transported in a solid state form. To realize the hydrogen economy, it is commonly believed that hydrogen must be cost-effectively generated, purified, compressed, stored, transported, distributed, and then safely used by end-users.

Hydrogen can be produced from coal, natural gas and other hydrocarbons, or formed by the electrolysis of water. In practice, hydrogen can be produced as a co-product in various industrial processes. For example, hydrogen is produced as a co-product in the electrolysis of aqueous alkali metal halide brines to yield the corresponding alkali metal hydroxide, the halogen, and hydrogen. Hydrogen is also produced as a co-product in the electrolysis of aqueous alkali metal sulfates to yield the alkali metal hydroxide, oxygen, and hydrogen. In all of these industrial processes, electrical power must be applied from an external power supply, across an anode and a cathode of an electrolytic cell, to yield oxygen or halogen at the anode, the alkali metal hydroxide at the cathode, and hydrogen as a cathode co-product. Currently, hydrogen produced from electrolysis of water is not competitive with gasoline due primarily to the added costs of delivery and storage. Renewable forms of energy could be used to electrolyze water, which would be a clean method of production, if fundamental improvements in efficiency can be achieved.

Globally, many scientists, policy-makers, government officials and concerned citizens have been advocating the accelerated establishment of a hydrogen infrastructure based on centralized hydrogen production with the stored hydrogen transported to properly distributed hydrogen-fueling stations much like the current network of gasoline-filling stations. For instance, Ovshinsky, et al. have proposed a hydrogen eco-system or infrastructure based on such a concept, as described in the following patents:
1. S. R. Ovshinsky, et al., “Hydrogen-based Ecosystem,” U.S. Pat. No. 6,305,442 (Oct. 23, 2001).
2. S. R. Ovshinsky, et al., “Hydrogen-based Ecosystem,” U.S. Pat. No. 6,519,951 (Feb. 18, 2003).
3. S. R. Ovshinsky, et al., “Hydrogen Infrastructure,” U.S. Pat. No. 6,591,616 (Jul. 15, 2003).
4. S. R. Ovshinsky, et al., “Hydrogen Infrastructure,” U.S. Pat. No. 6,672,078 (Jan. 6, 2004).
5. S. R. Ovshinsky, et al., “Method for Producing and Transporting Hydrogen,” U.S. Pat. No. 6,991,719 (Jan. 31, 2006).

The hydrogen infrastructure system as perceived by Ovshinsky, et al. (e.g., U.S. Pat. No. 6,305,442) includes (a) a power generation subsystem; (b) a hydrogen generation subsystem which uses power from the power generation subsystem to produce hydrogen; (c) a hydrogen purification/compression subsystem which purifies and compresses the hydrogen produced in the hydrogen generation subsystem; (d) a hydrogen storage subsystem which stores the purified and compressed hydrogen in metal hydride storage units; (e) a hydrogen transportation subsystem which transports metal hydride storage units containing stored hydrogen; (f) a hydrogen distribution subsystem which receives the transported metal hydride storage units and distributes the stored hydrogen to end users; and (g) an end-use subsystem which receives the distributed hydrogen and consumes the hydrogen.

Such an approach is based on the assumption that hydrogen, like gasoline or diesel, has to be generated at a central location such as a petroleum refinery since petroleum is not typically harvested in the backyard of a home or business. However, if we insist on building a centralized hydrogen supply infrastructure as perceived above, we would likely further delay the realization of hydrogen economy by additional 15 to 20 years. This is because it would be a long, tedious, and costly process to establish such a huge network of hydrogen-refueling stations nationwide or worldwide. Rather than following such an approach, it is our belief that one should be able to produce a desired amount of hydrogen at home for powering a personal vehicle, or even providing a sufficient amount of power for a home.

However, despite the above technical advantages of hydrogen as an energy source, the cost of hydrogen production has been too high hitherto for widespread use as a fuel, particularly for vehicular power applications. In the scenario of the production of hydrogen by electrolysis of water, a major factor in the high cost of production has been the cost of electricity to operate electrolysis cells. In this context, the electrolysis of water into H₂ and O₂ using solar radiation as a power source is an attractive method of producing hydrogen since it involves renewable and non-polluting energy sources: water and sunlight. The conversion of solar energy into chemical energy has the advantage of easy energy storage (in the form of the photon-generated fuel such as hydrogen). In the specific case of solar radiation-generated electricity, the high cost of electricity is due in large part to the relatively low efficiency of photovoltaic (or thermal) conversion of solar energy into electricity. Hence, a relatively large number of photovoltaic cells (or, in the case of thermal conversion, a large collection area) is required to generate a unit output of electricity.

Lasich disclosed a method and apparatus for the “production of hydrogen from solar radiation at high efficiency” (U.S. Pat. No. 5,658,448 (Aug. 19, 1997) and U.S. Pat. No. 5,973,825 (Oct. 26, 1999)). The method includes “converting solar radiation into thermal energy and electrical energy, and using a part of the thermal energy to convert water into steam and to heat the steam to a temperature of at least 700° C., and using the electrical energy and the remaining part of the thermal energy to operate an electrolysis cell to decompose the steam and to produce hydrogen and oxygen, with the thermal energy providing at least a part of the endothermic component of the electrolysis reaction and to significantly reduce the additional external electrical energy required to operate the electrolytic cell and increasing the efficiency of hydrogen production.” Experiments presented in these two patents showed a 40% augmentation of hydrogen production above that from solar electricity alone at a fuel cell electrolyzer operating temperature of 1000° C. This was a great accomplishment, but the approach has the following serious drawbacks:
(1) The system has to operate at a temperature greater than 700° C. and typically greater than 1000° C. and, hence, requires all related components (every thing from heat pipes to steam conduit) to work at such a high temperature. It is not a trivial task to operate and maintain such a high-temperature reactor system since one has to be concerned about such challenging issues as high temperature corrosion, leakage of ultra-high temperature steam (and possibly ultra-high pressure), insulation, high-temperature sealing, and high thermal expansion mismatch between components.
(2) The electrolysis cell at such a high temperature is a solid oxide fuel cell (SOFC), which is expensive and difficult to manufacture and operate reliably. The current SOFC technology is not mature, still unreliable and extremely expensive to manufacture. For instance, the current SOFC price is approximately US$2,000 per kW of power capacity, which is 5 to 10 times more expensive than a proton exchange membrane (PEM) fuel cell. Another significant contribution to the high system cost is the sub-system required to handle the extreme temperatures.
(3) The current total system cost is estimated as $18,490 for a 1 kW system [please see R. D. McConnel and J. R. Thompson, “Generating Hydrogen through Water Electrolysis Using Concentrator Photovoltaics,” Conference Paper NREL/CP-520-37093, presented at the 2004 DOE Solar Energy Technologies Program Review Meeting, Oct. 25-28, 2004 at Denver, Color. and J. R. Thompson, R. D. McConnell, and M. Mosleh, “Cost Analysis of a Concentrator Photovoltaic Hydrogen Production System,” NREL/CD-520-38172, presented at the International Conference on Solar Concentrators for the Generation of Electricity or Hydrogen,” May 1-5, 2005, Scottsdale, Ariz.]. The authors of these two papers hoped that, by Year 2020, the estimated system cost per kW (based on a 10 MW system) would be as low as $1,240.

Clearly, cost is the most critical issue associated with the current concentrator photovoltaics system for hydrogen production at high temperatures. A significant portion of this cost comes from the need to use a solid oxide fuel cell (SOFC) that typically operates at T>1,000° and the costly devices that comes with it to handle a high temperature environment. Lasich's patents were based on the notion that when the electrolysis process is run at high temperature (1,000° C.) the electrical voltage required to maintain a given output of hydrogen can be reduced provided there is a complementary increase in thermal energy input. However, these patents failed to realize that the thermodynamic efficiency of a fuel cell decreases when the operating temperature increases. As a result, the overall increase in energy efficiency is insignificant, which actually could not offset the high costs associated with the high temperature operation of the SOFC and solar cell systems.

One of the most efficient electrolyzers presently available is a solid polymer electrolyte (SPE) or proton exchange membrane (PEM) fuel cell unit, which basically consists of an anode and a cathode separated by a PEM layer. The electrodes are connected through an external circuit to a power supply. Water or aqueous electrolyte is decomposed at the anode into oxygen, hydrogen ions (protons) and electrons. The electrons flow through the external circuit to the cathodes while the protons flow through the PEM layer into the cathode where they combine with the electrons to form hydrogen molecules. PEM and alkaline fuel cells (AFC) are much less expensive than a SOFC and the PEM and AFC technologies are more mature and reliable. Using the PEM fuel cell as an example, the system typically operates at a temperature lower than 80° C. due to the thermal instability problem of the PEM material (e.g., Nafion®, a de factor industry standard PEM material) at higher temperatures. However, recent work by us and others have demonstrated that several new high-temperature PEM materials are now capable of operating at temperatures up to 300° C. (more typically up to 250°). This enables the PEM fuel cell to operate very efficiently at an intermediate temperature (between 80° C. and 300° C., more typically between 100° C. and 250° C.), where the electro-chemical reaction rates are maximal (beyond which temperature the PEM materials would degrade) and the combined energy efficiency (photovoltaic and solar heat) is improved without the high costs associated with excessively high operating temperatures (1,000° C.) of a required high-end solar concentrator and a SOFC.

### SUMMARY OF THE INVENTION

The present invention provides a personal hydrogen fueling method that is capable of producing hydrogen from solar radiation at a good efficiency via combined photovoltaic and thermal energy and then storing hydrogen safely at a home or business site. This hydrogen generation and storage method is devised for meeting personal vehicle hydrogen refueling needs. The method comprises (a) operating a solar energy conversion subsystem to capture and convert solar radiation into both electrical energy and thermal energy; (b) operating a fuel cell electrolyzer that uses the converted electrical energy and thermal energy to split water into hydrogen and oxygen wherein the fuel cell electrolyzer operates at a temperature between 80° C. and 300° C.; and (c) operating a hydrogen storage means to store the generated hydrogen. In a preferred embodiment, the solar energy conversion subsystem comprises a photovoltaic device to convert a portion of the captured solar radiation to electricity and a solar thermal device to convert another portion of the captured solar radiation to heat energy. The hydrogen storage means preferably comprises a hydrogen storage container that contains a solid or liquid phase material as a storage medium to capture and store the generated hydrogen therein, and control means to regulate the uptake of hydrogen in the storage container.

In one preferred embodiment, the solar energy conversion subsystem comprises means for separating the solar radiation into a shorter wavelength component (e.g., visible and ultraviolet) and a longer wavelength component (e.g., infrared wavelengths), and means for converting the shorter wavelength component into electricity and converting the longer wavelength component into heat energy. The means for separating may comprise apparatus for concentrating solar radiation and a mirror for selectively reflecting either the longer wavelength component or the shorter wavelength component of the solar radiation spectrum.

The solar thermal device may comprise a device or material selected from the group consisting of (a) a concentrator and a receiver; (b) an array of heliostats (large individually-tracking mirrors) and a power tower; (c) an infrared-absorbing material; (d) a thermal storage material; (e) a heat exchanger; or a combination thereof. Since no excessively high temperature operation is needed, the concentrator, receiver, mirrors, etc. can be very inexpensive versions. Surprisingly, we have found that conventional solar panels can be naturally heated by the sun to a temperature that can be harvested for use in heating water to be electrolyzed. An infrared-absorbing material can be implemented at a range of locations to help harvest the heat. A heat exchanger can be used to transfer the heat to the electrolyzer cell and water. Preferably, the fuel cell electrolyzer is a proton exchange membrane fuel cell or an alkaline fuel cell operating at a temperature between 100° C. and 250° C.

The hydrogen storage container comprises a solid or liquid phase material as a storage medium to capture and store the generated hydrogen and the container may be controlled by a control device to regulate storing or releasing of hydrogen in and from the storage container. The solid phase hydrogen storage material may comprise a material selected from the group consisting of a metal hydride, a chemical hydride, a carbon-based material, a nano material, a meso-porous structure, and combinations thereof.

The method may also involve a step of receiving electricity from another renewable energy source than solar (e.g., geothermal and wind) or directly from the grid to supplement the power needed for water electrolysis in situations where solar radiation is not sufficient or not readily available (e.g., on rainy days).

### BRIEF DESCRIPTION OF THE DRAWINGS

FIG. 1 Schematic of the primary components in a personal or home hydrogen fueling system that can be used to practice the presently invented method.

FIG. 2 Estimated energy input into an electrolysis cell (Source: R. D. McConnel and J. R. Thompson, “A Hybrid Solar Concentrator for the Electrolytic Production of Hydrogen,” A presentation given at DOE Solar Hydrogen Workshop, Nov. 9-11, 2004).

FIG. 3 Daily hydrogen production rates from three hydrogen generation systems based on photovoltaic cells with a solar-to-electricity efficiency of 7.1%, 10.2%, and 15.3%, respectively.

### DETAILED DESCRIPTION OF THE PREFERRED EMBODIMENTS

Described herein is a novel hydrogen generation and storage method for producing and storing hydrogen in a low-pressure container at a home or business site that enables refueling hydrogen to a personal vehicle at a convenient location. The method comprises (a) operating a solar energy conversion subsystem to capture and convert solar radiation into both electrical energy and thermal energy; (b) operating a fuel cell electrolyzer that uses the converted electrical energy and thermal energy to split water into hydrogen and oxygen wherein the fuel cell electrolyzer operates at a temperature between 80° C. and 300° C.; and (c) operating a hydrogen storage means to store the generated hydrogen. The hydrogen storage means preferably comprises (1) a hydrogen storage container comprising a metal hydride, chemical hydride, or other solid or liquid phase material as a storage medium to capture and store the generated hydrogen; and (2) control means to regulate the uptake of hydrogen in the storage container.

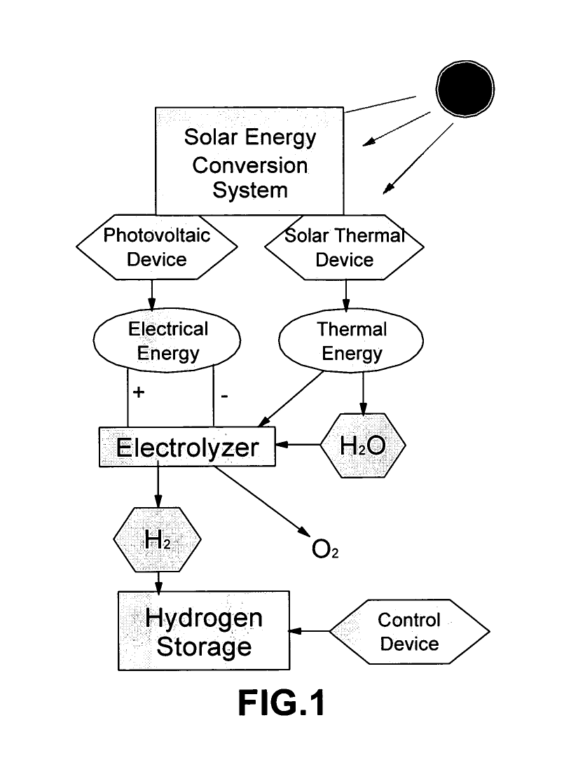

In one preferred embodiment, the presently invented method may involve operating a personal hydrogen refueling station that comprises four basic functional units or sub-systems (FIG. 1): (1) a solar energy conversion system; (2) a fuel cell-based electrolyzer; (3) a hydrogen storage container comprising a material such as metal hydride or chemical hydride as a storage medium to capture and store the generated hydrogen; and (4) control means to regulate the hydrogen storing or releasing procedures in and from the storage container.

The first two components constitute a hydrogen-generating unit. The solar energy conversion subsystem captures solar radiation and converts it to two useful forms of energy: electricity and heat. The subsystem comprises a photovoltaic device (or solar cell) to convert a portion of the captured solar radiation to electricity and a solar thermal device to convert another portion of the captured solar radiation to heat energy. The heat energy is used to help heat up the water or aqueous solution to be electrolyzed and/or to help bring the electrolyzer to a desired operating temperature. The fuel cell electrolyzer uses the converted electricity and heat to efficiently split water into hydrogen and oxygen, wherein the fuel cell electrolyzer operates at a temperature preferably between 80° C. and 300° C. (more preferably between 100° C. and 250° C.), as opposed to the solid oxide system that requires an operating temperature as high as 1000° C.

Solar cells or photovoltaic (PV) devices convert sunlight directly into DC electrical power. PV materials are typically based on (a) single crystalline semiconductor materials such as Si, Ge, and III-V or II-VI compounds, (b) polycrystalline semiconductors, (c) organic semiconductors, and (d) thin-film semiconductors which can be polycrystalline, nano-crystalline or amorphous.

Using thin-film semiconductors as an example, these multi-layer PV devices are typically configured to include an active layer, which is typically a cooperating sandwich of p-type, intrinsic (i-type), and n-type semiconductors. With appropriately located electrical contacts being included, the structure forms a working PV cell. When sunlight incident on PV cells is absorbed in the semiconductor, electron-hole pairs are created. The electrons and holes are separated by an electric field of a junction in the PV device. The separation of the electrons and holes by the junction results in the generation of an electric current and voltage. The electrons flow toward the n-type region and the holes flow toward the p-type region of the semiconductor material. Current will flow through an external circuit connecting the n-type region to the p-type region as long as light continues to generate electron-hole pairs in the PV device. Solar cells are typically arranged into PV modules by connecting the front of one cell to the back of another, thereby adding the voltages of the individual cells together. A large number of cells, typically 36 to 50, are required to be connected in series to achieve a nominal usable voltage of 12 to 18 V.

The last decade has seen a dramatic increase in commercial use and interest in both bulk crystalline and thin-film (micro-crystalline, nano-crystalline, or amorphous) PV devices. However, a wider scale commercial use of PV devices for bulk power generation remains limited primarily due to two factors: performance and cost. Recently, dramatic improvements in PV module performance have been achieved in both bulk crystalline silicon and thin film PV devices. The efficiency of laboratory scale crystalline silicon is approaching 25%, but commercially available modules typically show an efficiency ranging from 10 to 15%. Laboratory scale thin-film PV devices with efficiencies of well above 10% have been achieved with copper indium diselenide (CIS), cadmium telluride, amorphous silicon, and microcrystalline silicon. Most notably, an efficiency of 18.8% has been achieved for copper indium gallium diselenide (CIGS). Additionally, several companies have achieved thin-film large-area modules with efficiencies ranging from 8 to 12%. Multi-junction concentrator based PV systems have achieved an efficiency of 35%. Urgent needs still exist for further efficiency improvements and significant cost reduction in order to facilitate wide-scale commercialization of PV modules for power generation and particularly for the storage of solar energy in the form of hydrogen.

The present invention is not restricted to any particular type of solar cells. In fact, the invented approach can significantly improve the hydrogen-generating capability of a solar energy conversion subsystem featuring any type of PV device for solar-to-electric energy conversion. In addition to the PV device, the subsystem comprises a solar thermal device to convert a certain amount of the captured solar radiation to heat energy, which is used to heat up water (typically becoming steam) and enables an electrolysis cell to operate at a desired intermediate temperature. We have found that the fuel cell electrolyzer typically produces a maximum amount of hydrogen via water splitting when operating at a temperature between 80° C. and 300° C. (more preferably between 100° C. and 250° C. and most preferably between 120° C. and 200° C., particularly when a PEM fuel cell electrolyzer is utilized).

In one preferred embodiment, the solar energy conversion subsystem comprises means for separating the solar radiation into a shorter wavelength component (e.g., visible and ultraviolet wavelengths) and a longer wavelength component (e.g., infrared wavelengths (IR) and far IR), and means for converting the shorter wavelength component into electricity and converting the longer wavelength component into heat energy. This approach is adapted from Lasich (U.S. Pat. No. 5,658,448, Aug. 19, 1997) in that the means for separating may comprise an apparatus for concentrating solar radiation (e.g., a concentrator photovoltaic device, CPV) and a mirror for selectively reflecting either the longer wavelength component or the shorter wavelength component of the solar radiation spectrum. The differences lie in the notion that no expensive CPV unit or spectral splitter is required in our system since we do not need to heat water to 1000° C. as required in Lasich's system. We do not need to use those expensive heat exchangers and conduits that are required by Lasich since an expensive solid oxide fuel cell (SOFC) as an electrolysis cell is not required nor used in our case. Since our system requires the operation of a much less expensive and more reliable lower-temperature fuel cell (e.g., PEM or alkaline fuel cell) at a temperature lower than 300° C. (most preferably lower than 250° C.), the much reduced amount of heat energy can be easily and readily obtained from the solar energy captured by a simpler or less expensive solar thermal device.

The solar thermal device may comprise a device or material selected from the group consisting of (a) a concentrator and a receiver; (b) an array of heliostats (large individually-tracking mirrors) and a power tower; (c) an infrared-absorbing material; (d) a thermal storage material; (e) a heat exchanger; (f) a solar thermal collector; or a combination thereof. There are three solar thermal power systems currently being developed in the solar power industry: parabolic troughs, power towers, and dish/engine systems. Selected components of these systems can be used herein to harvest heat energy from solar radiation. Since no excessively high temperature operation is needed, the concentrator, receiver, mirrors, etc. can be very inexpensive versions. Surprisingly, we have found that conventional solar panels can be naturally heated by the sun to a temperature that can be harvested for use in heating the water being electrolyzed. In particular, we have observed that a multi-junction PV module, when exposed to solar radiation, tends to produce an excessively high amount of heat that must be properly dissipated in order for the PV system to function properly as an electrical energy producer. For the purpose of generating electricity only, this heat would have been wasted since a cooling device would have to be used for heat dissipation. Further, this heat is insufficient to elevate the water temperature to 700 or 1000° C. (and, hence, cannot be used in Lasich's system); but surprisingly, this heat can be used to convert water to steam at typically 100° C. to 200° C. This may be understood if we realize that a multi-junction PV module typically contains semiconductor materials covering a range of band gaps with some energy gaps corresponding to IR or far IR ranges. Although these band gaps were designed to allow a wider spectrum of solar radiation energy to be captured and used to generate electron-hole pairs, a significant amount of the captured energy is actually expended in producing heat. An inexpensive heat exchanger can be used to transfer the heat to the electrolyzer cell and water in the present invention.

In a most simple configuration, an infrared-absorbing material can be implemented at a range of locations near a solar cell to help harvest the heat. Infrared absorbents are well-known in the art. For instance, carbon blacks or a metal complex compound prepared by coordinating a thiorato bidentate ligand and a nitrogen-containing bindentate ligand to a center metal (e.g., Suzuki, et al., U.S. Pat. No. 4,730,902, Mar. 15, 1988). A thermal storage material may be used to store the solar energy first, which is used at a later time. The use of phase change materials (PCMs) for thermal storage is also well-known in the art. In many materials much more heat can be stored as latent heat of phase change than as sensible heat. Some of the phase transitions that involve significant amounts of latent heat are solid-to-liquid or liquid-to-gas phase changes or, in certain materials, solid-to-solid phase changes. Another subgroup of PCMs uses reversible exothermic reactions, such as hydration-dehydration or solution-precipitation reactions, for heat storage. The latent heat of phase change can be used for heating or cooling depending on whether the phase change is exothermic or endothermic. In most materials, the phase changes are reversible so that the latent heat storage can be used for either heating or cooling depending on the temperature conditions.

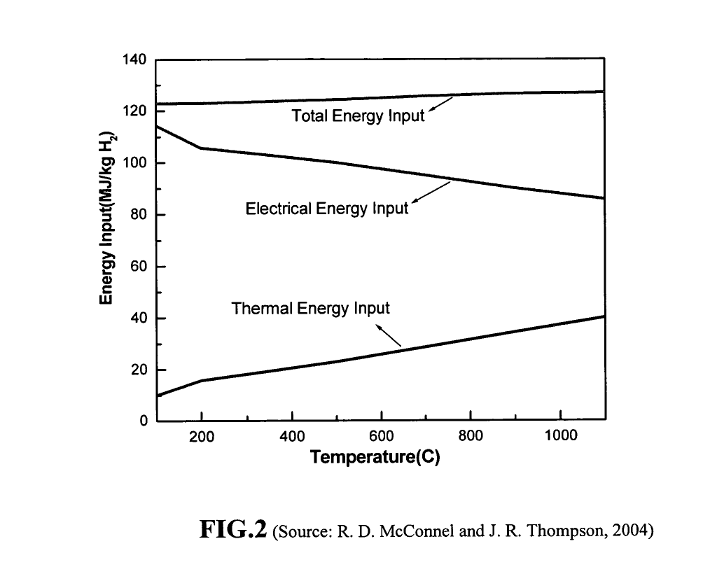

It is interesting to note that it might be perceived as advantageous to operate a solar hydrogen production system at a high temperature (e.g., 1000° C.), as pointed out by Lasich or others (e.g., R. D. McConnel and J. R. Thompson, “A Hybrid Solar Concentrator for the Electrolytic Production of Hydrogen,” A presentation given at DOE Solar Hydrogen Workshop, Nov. 9-11, 2004). However, as indicated in FIG. 2 for a solid oxide fuel cell-based electrolysis system, although the thermal energy input into the electrolyzer increases with increasing temperature, the electrical energy input decreases. Consequently, the increase in total energy input is minimal (e.g., from 123 to 128 MJ/kg H₂ for a temperature increase from 100° C. to 1100° C.). Further, it is well-known that the thermodynamic efficiency of a fuel cell decreases significantly with increasing fuel cell operating temperature. It is questionable if the overall energy gain can be justified by the much higher costs associated with a high temperature operation (at 1000° C.).

Preferably, the cell electrolyzer comprises a proton exchange membrane (PEM) fuel cell or an alkaline fuel cell (AFC) operating at a temperature between 100° C. and 250° C. Particularly preferred is a PEM fuel cell due to its low cost, simplicity, safety, ease of handling, and technical maturity. However, the conventional PEM fuel cell based on poly (perfluoro sulfonic acid) (PFSA, such as du Pont's Nafion®), its derivative, copolymer, or mixture) can only operate up to approximately 80° C. A prolonged use of Nafion® at a higher temperature leads to an irreversible degradation of the membrane. Fuel cells with thermally stable PEM that operate at higher temperatures (between 100° C. and 250° C.) offer several advantages: increased catalytic activity (fast electrode kinetics), possible use of non-precious metal electro-catalysts, higher tolerance to fuel impurities, and possible use of solar heat.

Higher temperature materials suitable for use as proton conducting membranes in the PEM-based electrolysis cell include, but are not limited to, sulfonated versions of the following polymers: polyetheretherketone (PEEK), polyethersulfone (PES), perfluoroalkoxy (PFA), fluorinated ethylene propylene (FEP), polybenzimidazole, polyethersulfone, poly(phenylene oxide), and copolymers and mixtures thereof. The polymer matrix preferably has a melting point or glass transition point in the range from about 100° C. to about 350° C. These polymers, prepared in a thin film form (preferably 10-100 μm in thickness) can be used as a solid electrolyte membrane in a PEM fuel cell type electrolyzer. The hydrogen production rate of such an electrolyzer is preferably in the range of 0.04 to 1 Kg/hour. The operating temperature is typically between 80° C. and 300° C., but preferably between 100° C. and 250° C.

In the presently invented personal or home hydrogen fueling method, hydrogen produced by solar electrolysis is preferably stored in a material-based hydrogen storage system, as opposed to in liquid hydrogen or compressed hydrogen storage tanks. Such a system typically comprises a container (e.g., a small canister) that contains a hydrogen storage material therein. Preferred hydrogen storage materials are metal hydrides, chemical hydrides, carbon-based materials (e.g., carbon nano-tubes and carbon nano fibers), nano materials, and meso-porous materials. There are three basic mechanisms for storing hydrogen in these materials: absorption, adsorption, and chemical reaction. In absorption, hydrogen is absorbed directly into the bulk of the material. In simple crystalline metal hydrides, this absorption occurs by the incorporation of atomic hydrogen into interstitial sites in the crystal structure. Adsorption may be subdivided into physisorption and chemisorption, based on the energetics of the adsorption mechanism. Physisorbed hydrogen is more weakly bound to the material than is chemisorbed hydrogen. Further, sorptive processes typically require highly porous materials to maximize the surface area available for hydrogen sorption to occur, and to allow for easy uptake and release of hydrogen from the material. The chemical reaction route for hydrogen storage involves displacive chemical reactions for both hydrogen generation and hydrogen storage.

Metal hydrides have the potential for reversible on-board and off-board (e.g., at home) hydrogen storage and release at low temperatures and pressures. The optimum operating P-T window for on-board PEM fuel cell applications is in the range of 1-10 atm and 25-120° C. This is based on using the waste heat from the fuel cell to release the hydrogen from the media. This window of temperatures and pressures is also ideal for storing solar hydrogen by a metal hydride. Many hydrides of metals, metal alloys, or inter-metallic compounds may be used for hydrogen storage. A simple metal hydride such as LaNi₅H₆, that incorporates hydrogen into its crystal structure, can function in this range, but its gravimetric capacity is too low (˜1.3 wt. %).

Hence, preferred hydrogen storage materials are complex metal hydrides such as alanate (AlH₄) materials, which have higher gravimetric hydrogen capacities in the operational window than simple metal hydrides. When doped with titanium, alanates can store and release hydrogen reversibly, according to the following 2-step displacive reaction for sodium alanate:

NaAlH₄=⅓ Na₃AlH₆+⅔ Al+H₂

Na₃AlH₆=3 NaH+Al+ 3/2 H₂

At 1 atm pressure, the first reaction becomes thermodynamically favorable at temperatures above 33° C. and can release 3.7 wt. % hydrogen. The second reaction proceeds above 110° C. and can release 1.8 wt. % hydrogen. The amount of hydrogen that a material can release, rather than only the amount the material can hold, is the key parameter used to determine net gravimetric and volumetric capacities of a system (including storage material and container, etc.).

Another preferred metal hydride-based hydrogen storage material group is a complex hydride system based on lithium amide. For this system, the following reversible reaction takes place at 285° C. and 1 atm: Li₂NH+H₂═LiNH₂+LiH. In this reaction, 6.5 wt. % hydrogen can be reversibly stored, with potential for 10 wt. %. Further, the temperature of this reaction can be lowered to 220° C. with magnesium substitution, although at higher pressures.

Still another class of hydrogen storage materials for use in the present invention is based on the storage technologies in which hydrogen is generated through a chemical reaction such as hydrolysis and hydrogenation-dehydrogenation. Common reactions involve chemical hydrides with water or alcohols. Typically, these reactions are not easily reversible on-board a vehicle. Hence, the spent fuel and/or byproducts must be removed from the vehicle and regenerated off-board. However, this is not an issue for the presently invented home hydrogen fueling system. Hydrolysis reactions involve the oxidation reaction of chemical hydrides with water to produce hydrogen.

For sodium borohydride, the reaction is: NaBH₄+2H₂O═NaBO₂+4H₂. In real practice, a slurry of an inert stabilizing liquid may be used to protect the hydride from contact with moisture. At the moment of actual use, the slurry is mixed with water and the consequent reaction produces high purity hydrogen. The reaction can be controlled in an aqueous medium via pH and the use of a catalyst.

Another hydrogen storage technology that can be incorporated in the presently invented system is based on the hydrolysis reaction of MgH₂ with water to form Mg(OH)₂ and H₂. Particles of MgH₂ may be contained in a non-aqueous slurry to inhibit premature water reactions when hydrogen generation is not required. Material-based capacities for the MgH₂ slurry reaction with water can be as high as 11 wt. %. However, similar to the sodium borohydride approach, the Mg(OH)₂ must be regenerated off board, which again is not a concern in practicing the present invention.

Still another preferred hydrogen storage technology is based on the hydrogenation and dehydrogenation reactions. For example, the decalin-to-naphthalene reaction can release 7.3 wt. % hydrogen at 210° C. via the reaction: C₁₀H₁₈═C₁₀H₈+5H₂. A platinum-based or noble metal supported catalyst is required to enhance the kinetics of hydrogen evolution. The chemical approaches may also be based on the concept of reacting lightweight metal hydrides such as LiH, NaH, and MgH₂ with methanol and ethanol (alcoholysis). Alcoholysis reactions may lead to controlled and convenient hydrogen production at room temperature and below.

The hydrogen storage material can be a liquid phase material, as that developed by Air Products and Chemicals, Inc., (e.g., G. P. Pez, et al. U.S. Pat. No. 7,101,530 (Sep. 5, 2006)). The storage and release of hydrogen is by means of a substantially reversible catalytic hydrogenation of extended pi-conjugated substrates which include large polycyclic aromatic hydrocarbons, polycyclic aromatic hydrocarbons with nitrogen heteroatoms, polycyclic aromatic hydrocarbons with oxygen heteroatoms, polycyclic aromatic hydrocarbons with alkyl, alkoxy, ketone, ether or polyether substituents, π-conjugated molecules comprising 5-membered rings, π-conjugated molecules comprising six- and five-membered rings with nitrogen or oxygen hetero atoms, and extended π-conjugated organic polymers. The hydrogen, contained in the at least partially hydrogenated form of the extended π-conjugated system, can be facilely released for use by a catalytic dehydrogenation of the latter in the presence of a dehydrogenation catalyst which can be effected by lowering the hydrogen gas pressure, generally to pressures greater than 0.1 bar or raising the temperature to less than 250° C. or less, or by a combination of these two process parameters. This class of liquid materials has shown a 5-7 wt. % gravimetric hydrogen storage capacity and a greater than 0.050 kg/L hydrogen volumetric capacity. They can be used as a hydrogen storage medium in the presently invented home fueling station.

Reversible hydrogen storage and generation by and from ammonia-borane materials may be represented by the following reactions: NH₃BH₃═NH₂BH₂+H₂═NHBH+H₂. The first reaction, occurring at less than 120° C. releases 6.1 wt. % hydrogen. The second reaction, which occurs at approximately 160° C., releases 6.5 wt. % hydrogen. The system may be built by incorporating ammonia-borane nano-sized particles in a meso-porous scaffold, as suggested by T. Autrey of the US DOE Pacific Northwest National Laboratory (“Chemical Hydrogen Storage: Control of H₂ Release From Ammonia Borane,” a poster presented at the 2004 DOE Hydrogen Program Review, May 2004, Philadelphia).

The hydrogen storage container (e.g., a canister) may be designed in such a manner that it can be easily detached from the presently invented hydrogen fueling station and plugged into a canister-holding device located near a fuel cell or hydrogen combustion engine of a vehicle. A simple temperature- and pressure-regulating sub-system may be employed to provide the required hydrogen pressure and hydrogen storage material temperature to achieve rapid and efficient uptake of hydrogen via absorption, adsorption, or a chemical reaction. Typically, near ambient pressure is involved in storing hydrogen in the solid or liquid material and no gas compressor is required in most of the cases. When not in use, the hydrogen produced is stored as a solid hydride or liquid medium. This features eliminates the inconveniences and potential hazards associated with storing hydrogen as a compressed gas. Operating the solid or liquid phase material storage system and electrolyzer at low pressures, as used in the presently invented system, reduces the chance of leakage and explosion, permits simpler sealing configurations, allows for the use of less expensive construction materials, reduces the chance of structural fatigue, allows for easy assembly of the entire system, and eliminates compressor pulsations or vibrations which can cause structural damage and leakage.

One canister or several canisters at a time may be used by the fuel cell system or hydrogen combustion engine in a vehicle to provide the driving power therefor. Once the car is driven home or when a canister is out of hydrogen, the canister can be put back to the home hydrogen fueling station for recharge. The vehicle may be replenished with a fully charged canister. The recharge process of an empty canister may occur on the same day (if sun shine is still available) or on a later day. If necessary, extra canisters can be stored in a vehicle for a longer distance trip. It may be noted that part of the heat required to activate the release of hydrogen from a canister can come from the exhaust heat generated by the on-board fuel cell or combustion engine.

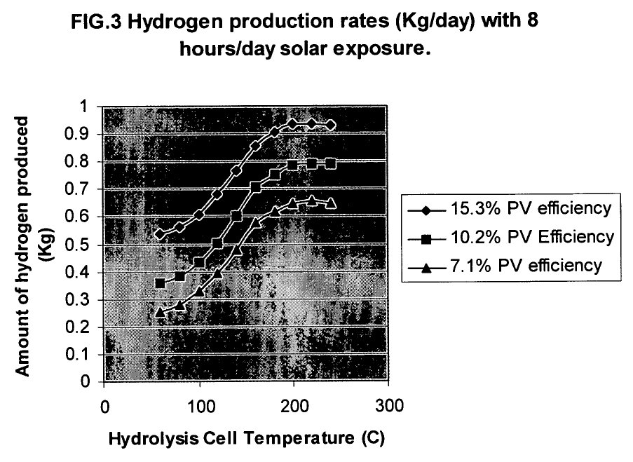

In order to demonstrate the advantages of converting a portion of the captured solar energy to power a fuel cell-based electrolyzer and another portion to heat up the water to be electrolyzer and the electrolysis cell itself, we used three solar cells based on a photovoltaic efficiency of 7.1%, 10.2%, and 15.3%, respectively. They are small PV cells that each cover a solar radiation collection area of approximately 0.25 m², providing approximately 17.75 W, 25.5 W, and 38.25 W of electrical power, respectively. The hydrogen production rate was scaled up by a factor of 100 (i.e., assuming a PV cell area of 25 m² in future actual use) and calculated based on an 8 hours per day solar radiation exposure. Heat was used to bring the water temperature to the range of 60° C. to 240° C. The daily hydrogen production amounts (extrapolated to 25 m² PV area and 8 hours of operation) for these three systems are given in FIG. 3. Several interesting observations can be made from this chart:
(1) The hydrogen production rate in each case can be significantly increased by operating a fuel cell electrolyzer at a higher temperature (up to 240° C.). The increments are relatively independent of the PV efficiency, implying that these improvements are primarily due to higher cell operating temperatures (likely caused by much enhanced electro-catalytic activities).
(2) At a PV efficiency of 15.3% and PV area of 25 m², and with an electrolysis cell operating at 240° C., we can obtain 0.93 Kg of hydrogen per day, which is close to the average daily hydrogen requirement of a car driver going from home to work and back. This is judged on the basis of a DOE estimate (hydrogen production amount of 200-1000 Kg per year at a house to serve 1-5 cars): approximately 1 Kg a day (J. Levene, M. Mann, and A. Milbrandt, “Electrolysis Overview,” Solar Hydrogen Workshop, Nov. 9-10, 2004, UMUC Conference Center. Adelphi, Md.). It may be noted that 1 Kg of hydrogen will enable a small car with a small fuel cell engine to run for 40 to 50 miles.
(3) The results show 75% augmentation of hydrogen production above that from solar electricity alone at a fuel cell electrolyzer operating temperature of 220° C., in contrast to the 40% improvement in Lasich's system that had to operate at 1000° C.
(4) With an improved PV system (e.g., a PV efficiency of 32% has been achieved with multi-function systems in laboratories), a daily production rate of 1.5 Kg is now readily achievable. If deemed necessary, a higher hydrogen genration rate can come from a larger PV system. The PV area of 25 m² can be easily accommodated on the roof top of a typical American house garage.

It may be noted that the presently invented personal or home hydrogen fueling system or method may work in combination with other renewable energy technologies such as wind and geothermal. In its worse case scenario where there is not enough sunshine on a particular day, electricity from another renewable energy source or directly from the grid can be used to supplement the needed electricity for electrolyzing water. Hence, the presently invented system may be provided with connections to an electricity supply from other sources.

The present invention has demonstrated the feasibility of using primarily renewable energy sources to produce and safely store hydrogen to meet personal transportation needs. Although it may still be convenient to have neighborhood hydrogen fueling stations or stations around major highways, the realization of a hydrogen economy no longer hinges upon the establishment of a huge number of centralized or distributed hydrogen fueling stations. As the solar energy conversion technology continues to advance and PV and fuel cell system costs continue to decrease, the presently invented home hydrogen fueling system will become even more affordable and will have a major impact on the global efforts to curtail carbon dioxide emissions and other pollutants associated with the production and use of fossil energies.

1. A hydrogen generation and storage method for meeting personal vehicle hydrogen refueling needs, said method comprising:
a) operating a solar energy conversion subsystem to capture and convert solar radiation into both electrical energy and thermal energy;
b) operating a fuel cell electrolyzer that uses the converted electrical energy and thermal energy to split water into hydrogen and oxygen wherein said fuel cell electrolyzer operates at a temperature between 80° C. and 300° C.; and
c) operating a hydrogen storage means to store the generated hydrogen.

2. The hydrogen generation and storage method of claim 1 wherein said solar energy conversion subsystem comprises means for separating the solar radiation into a shorter wavelength component and a longer wavelength component, and means for converting the shorter wavelength component into electrical energy and converting the longer wavelength component into thermal energy.

3. The hydrogen generation and storage method of claim 2 wherein said means for separating comprises means for concentrating solar radiation and means for selectively reflecting either the longer wavelength component or the shorter wavelength component of the solar radiation spectrum.

4. The hydrogen generation and storage method of claim 1 wherein said operation of converting solar radiation to thermal energy comprises using a device or material selected from the group consisting of (a) a concentrator and a receiver; (b) an array of heliostats and a power tower; (c) an infrared-absorbing material; (d) a thermal storage material; (e) a heat exchanger; and combinations thereof.

5. The hydrogen generation and storage method of claim 1 wherein said fuel cell electrolyzer comprises a proton exchange membrane fuel cell or an alkaline fuel cell operating at a temperature between 100° C. and 250° C.

6. The hydrogen generation and storage method of claim 1 wherein said hydrogen storage means comprises:
(i) a hydrogen storage container comprising a solid or liquid phase material as a storage medium to capture and store said generated hydrogen therein; and
(ii) control means to regulate the uptake of hydrogen in said storage container.

7. The hydrogen generation and storage method of claim 6 wherein said solid phase material comprises a material selected from the group consisting of a metal hydride, a chemical hydride, a carbon-based material, a nano material, a meso-porous structure, an ammonia-borane material, and combinations thereof.

8. The hydrogen generation and storage method of claim 6 wherein said solid or liquid phase material stores hydrogen therein via a mechanism of absorption, adsorption, chemical reaction, or a combination thereof.

9. The hydrogen generation and storage method of claim 1 further comprising a step of operating means for receiving, on demand, electrical energy from a different source than solar energy.

10. The hydrogen generation and storage method of claim 6 further comprising a step of operating means for receiving, on demand, electrical energy from a different source than solar energy.

11. The hydrogen generation and storage method of claim 1 wherein said operation of a solar radiation conversion subsystem comprises operating a photovoltaic device at a solar-to-electricity efficiency of at least 15%.

12. The hydrogen generation and storage method of claim 6 wherein said operation of a solar radiation conversion subsystem comprises operating a photovoltaic device at a solar-to-electricity efficiency of at least 15%.

13. The hydrogen generation and storage method of claim 1 wherein said operation of a solar radiation conversion subsystem comprises operating a photovoltaic device at a solar-to-electricity efficiency of at least 30%.

14. The hydrogen generation and storage method of claim 1 wherein said operation of a solar radiation conversion subsystem comprises operating a photovoltaic device at a solar-to-electricity efficiency of at least 30%.

15. The hydrogen generation and storage method of claim 1 wherein said electrolyzer generates hydrogen at a rate of at least 0.1 kilograms per hour.

16. The hydrogen generation and storage method of claim 6 wherein said electrolyzer generates hydrogen at a rate of at least 0.1 kilograms per hour.

17. The hydrogen generation and storage method of claim 1 wherein said electrolyzer generates hydrogen at a rate of at least 1 kilogram per day.

18. The hydrogen generation and storage method of claim 6 wherein said electrolyzer generates hydrogen at a rate of at least 1 kilogram per day.

19. The hydrogen generation and storage method for meeting personal vehicle hydrogen refueling needs as defined in claim 6, further comprising a step of disconnecting said hydrogen storage container from said electrolyzer and placing said container in a vehicle to feed hydrogen to a fuel cell or combustion engine in said vehicle.

20. The hydrogen generation and storage method of claim 19 further comprising a step of using heat generated by a fuel cell or a combustion engine on board a vehicle to facilitate release of hydrogen from said container.
